(19) United States
(12) Patent Application Publication
(10) Pub. No.: US 2011/0101793 A1
(43) Pub. Date: May 5, 2011

(54) Voice Control Energy-Saving Power Socket

(76) Inventor: Jen-Ho Chang, Taipei County (TW)

(21) Appl. No.: 12/609,017

(22) Filed: Oct. 30, 2009

(51) Int. Cl. H02H 3/00

(52) U.S. Cl. 307/131

(57) ABSTRACT

The present invention provides a voice control energy-saving power socket that uses voice control to power up and achieve time, labor and energy saving. When an electrical equipment is turned off, the present invention can automatically detect current change and completely isolate the input power source and the electrical equipment to prevent wasting energy. When the power is needed, voice control is used to power up. To achieve the above objective, the technical approach for the present invention comprises an overload protection circuit to detect whether the input power is overloaded, a load detection circuit to detect the load size and determine whether the output control circuit needs to be on or off, an output control circuit is to switch between power-off mode and power-up mode, a voice control circuit is to activate the output control circuit and allow connection between the power source and the load and an internal power circuit is to supply power to the overload protection circuit and the load detection circuit in power-off mode.

### BACKGROUND OF THE INVENTION

1. Field of the Invention

The present invention is related to an energy saving voice control power socket, especially a voice control power cable that can isolate input power source from electrical equipment.

2. Description of the Prior Art

Many current power cables are actually not isolated from input power source when electrical equipment is turned off. Actually, the interior of the electrical equipment is still in power-up state unless the power source is manually switched off. Otherwise, the input power source cannot be completely isolated from the electrical equipment. Therefore, as long as electrical equipment is connected to power source, it will consume electricity no matter it is in use or idle, which becomes an invisible energy waste. Since normal power cables are located in a corner or on a ground that is difficult to reach, it is very inconvenient to manually isolate the load from the power source.

### SUMMARY OF THE INVENTION

One objective of the present invention is to provide a voice control energy-saving power socket that uses voice control to turn on power source and achieve time, effort and energy saving.

Another objective of the present invention is to provide a voice control energy-saving power socket that can automatically detect electric current change and completely isolate the power source from the electrical equipment when electrical equipment is turned off to prevent wasting energy. When there is a need to use the electrical equipment again, it will use voice control to connect the power.

To achieve the above objectives, the technical approaches for the present invention include: an overload protection circuit to detect whether input current is overloaded and determine whether it needs to isolate input power; a load detection circuit to detect load size and determine whether output control circuit switch needs to be on or off; an output control circuit to switch between power-off mode and power-up mode according to the load detection circuit result to prevent wasting energy; a voice control circuit to use voice control to activate output control circuit and allow connection between the power source and the load; and an internal power circuit to supply power to the overload protection circuit and the load detection circuit in power-off mode.

To further make the above objectives, functions and features for the present invention understandable, the following description is provided with illustrative figures.

### BRIEF DESCRIPTION OF THE DRAWINGS

FIG. 1 shows a functional block diagram for the present invention.

FIG. 2 shows an input switch and the overload protection circuit for the present invention.

FIG. 3 shows an output control circuit for the present invention.

FIG. 4 shows a load detection circuit for the present invention.

FIG. 5 shows a voice control circuit for the present invention.

FIG. 6 shows an internal power circuit for the present invention.

FIG. 7 shows an overall circuit diagram of the present invention

### DETAILED DESCRIPTION OF A PREFERRED EMBODIMENT

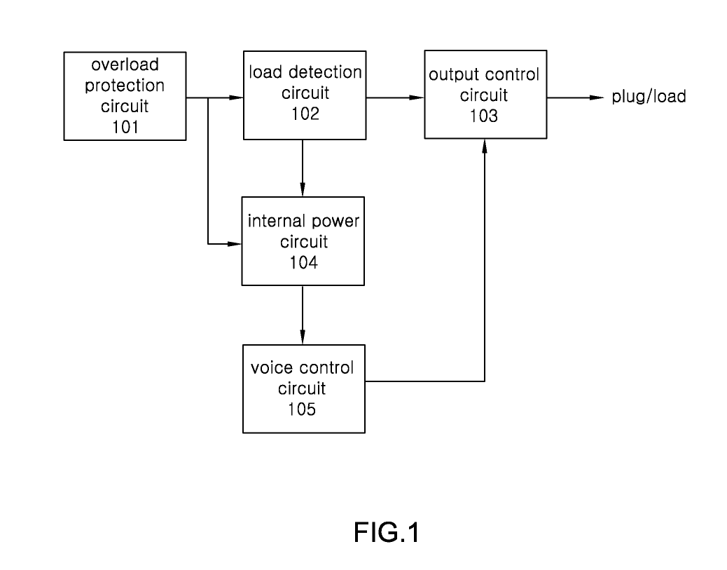

Please refer to the functional block diagram in FIG. 1. The present invention consists primarily of six blocks in the process flow diagram, including overload protection circuit 101, load detection circuit 102, output control circuit 103, internal power circuit 104, and voice control circuit 105. The operations in the process flow diagram are described below respectively.

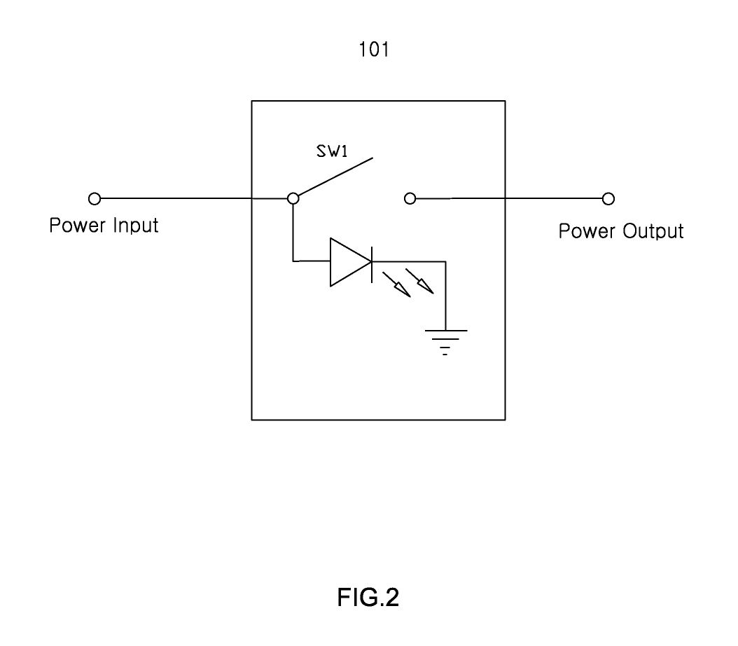

FIG. 2 shows input switch and overload protection circuit 101. The overload protection circuit 101 can detect input current to control input power to be power-up state (ON) or power-off state (OFF). When the input current is higher than the specification of overload protection circuit switch SW1, SW1 will switch to power-off state (OFF); while the input current is lower than the specification, the switch is back to power-up state (ON) to prevent circuit malfunction.

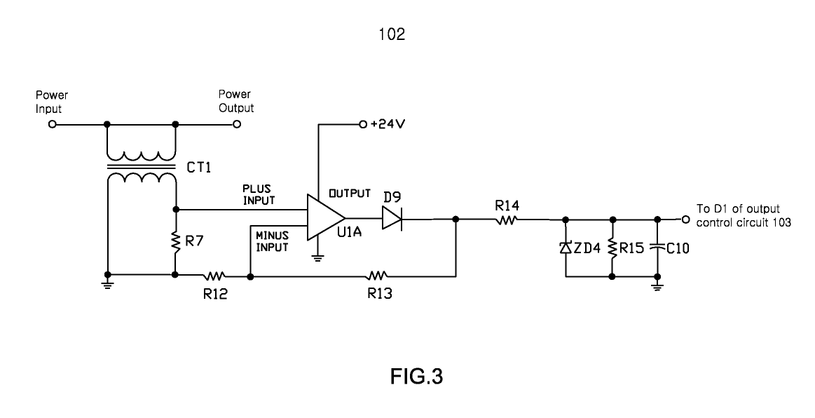

FIG. 3 shows load detection circuit 102 that detects load current size and determines control output circuit 103 to switch on or off. When the load current is lower than, for example, 0.18 A, output control signal will change to low voltage, allowing output control relay RY1 to activate, i.e. power-off mode. A simple model can only determine whether load current is lower than the setting and shut off output if current is lower than power cable setting, i.e. shutting off output; a higher level model can use central controlled process unit (CPU) to memorize user load current as the criterion to determine whether to shut off the output. When a load is connected to the power cable in the first time, the current for the load in use and standby can be memorized, which prevents standby mode mistakenly determined by the load detection circuit and power shutoff due to overly low load current.

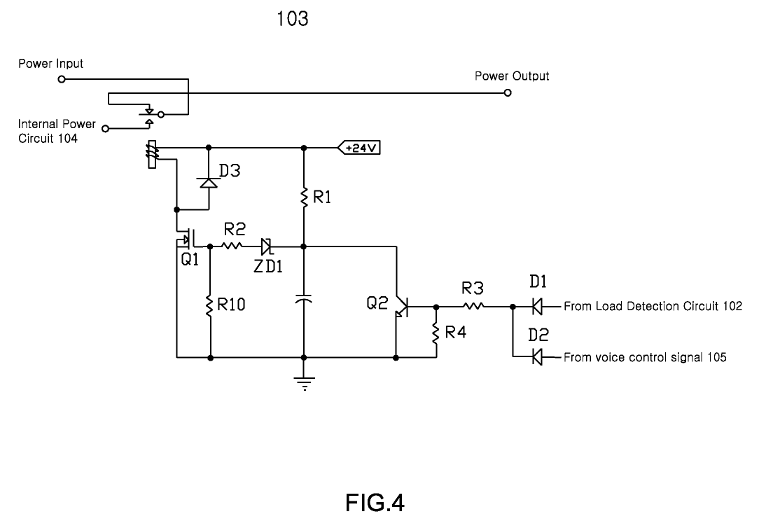

FIG. 4 shows output control circuit 103. When the load current is lower than the setting, load detection signal from Load detection circuit 102 will change from high voltage to low voltage, Q2 will automatically shut off, in turn, Q1 turn on and relay RY1 will power on, and power output will be in power-off state; when voice signal from voice control circuit 105 is received, the voice control signal will change from low voltage to high voltage, Q2 will automatically turn on, in turn, Q1 turn off and relay RY1 will power off, and power output will be back in power-up state.

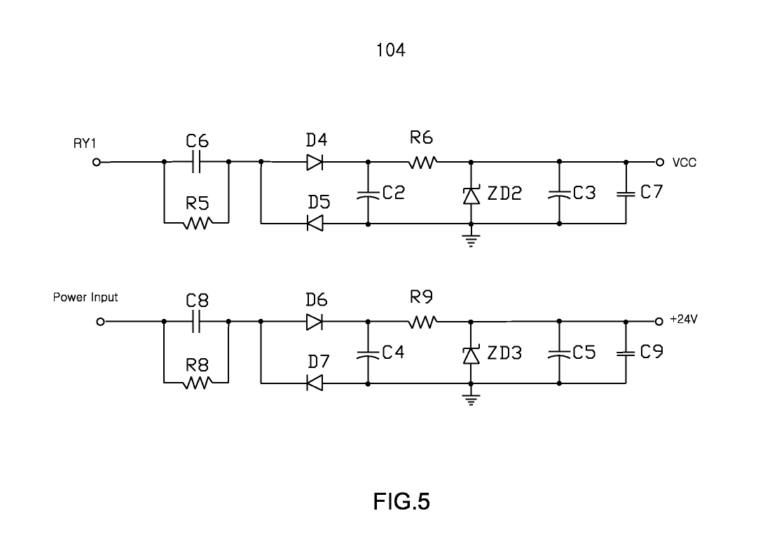

FIG. 5 shows internal power circuit 104 that supplies power to overload protection circuit 101 and load detection circuit 102 during power-off state.

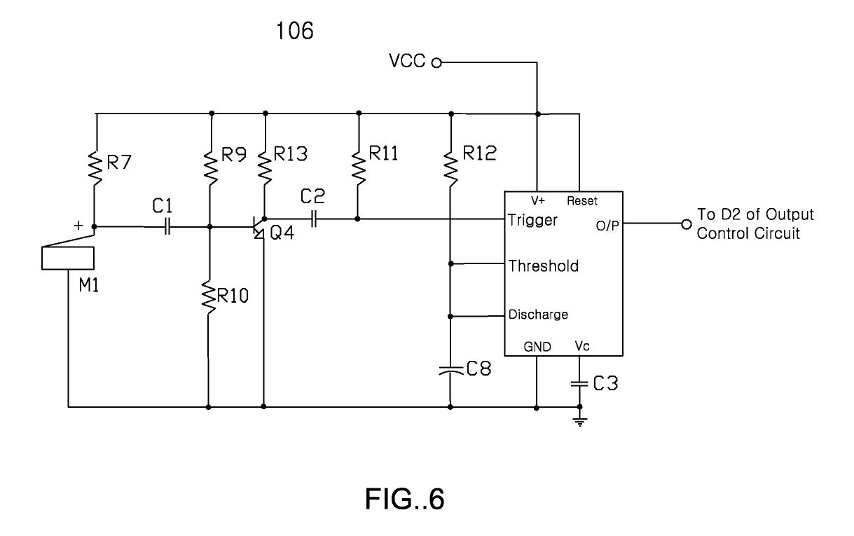

FIG. 6 shows voice control circuit 105. When a microphone (M1) receives voice signal, voice control signal will change from low voltage to high voltage, allowing power cable output to be in power-up state. If the output control circuit 103 is in power-up state, the voice control circuit 105 power will shut off and new voice signal will not produce commanding effect on the circuit.

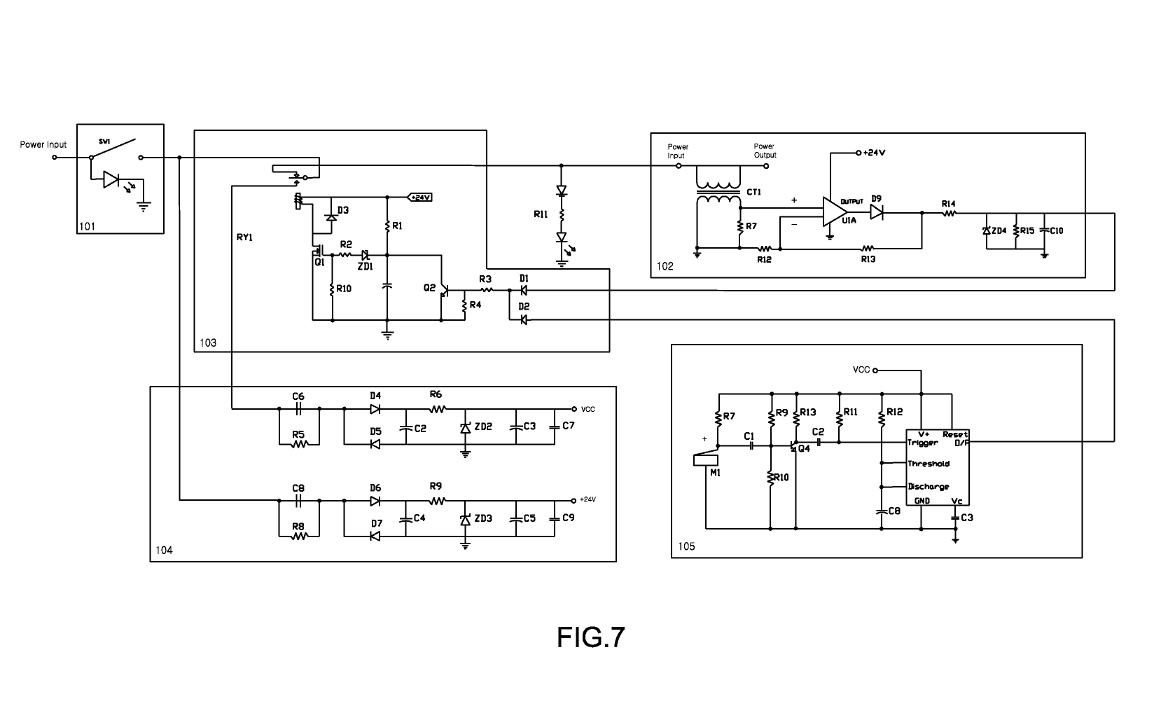

FIG. 7 shows the overall circuit diagram of the present invention. Since the present invention is aiming at the arrangement of functional circuits block diagrams to achieve the goal of energy-saving voice control power socket, the details of conventional circuits operation in the circuit diagram will not be explained herewith.

Currently each personal computer (main unit and monitor) consumes approximately 20 W for one-hour standby. If there are 16 standby hours in a day, there will be a saving of approximately one kWh of electricity in three days (20×16×3/1000=0.96≈1 kWh of electricity). In general, the present invention has outperformed the current technology and been able to achieve energy saving. Besides, the present invention, which has not been published before the application, has its characteristics and practicality to meet patentability requirements. Therefore, the patent application is submitted for approval.

What is claimed is:

1. A voice control energy-saving power socket at least comprises:
an overload protection circuit, a load detection circuit to detect whether input current is overloaded a protection circuit switch,
an load detection circuit to detect load size and determine whether output control circuit switch needs to be on or off,
an output control circuit to switch between power-off mode and power-up mode,
an internal power circuit to supply power to the overload protection circuit and the load detection circuit while in power-off mode, and
a voice control circuit to activate the output control circuit and allow connection between the power source and the load.

2. The voice control energy-saving power socket of claim 1, wherein the overload protection circuit is to control power input as in power-up state or power-off state, when the input power is higher than specification of the protection circuit switch, the circuit will switch to power-off state; when the input power is lower than specification of the protection circuit switch, the circuit will switch to power-up state.

3. The voice control energy-saving power socket of claim 1, wherein the load detection circuit is to determine whether to shut off power output, when the load current is lower than 0.18 A, if so, the output control signal changes to low voltage, activating the output control relay and shutting off power output.

4. The voice control energy-saving power socket of claim 1, wherein the load detection circuit can use a central controlled process unit to memorize user load current.

5. The voice control energy-saving power socket of claim 1, wherein when the load current is lower than the setting, the output control circuit will receive a load detection signal with a level from high voltage changes to low voltage.

6. The voice control energy-saving power socket of claim 1, wherein when the output control circuit receives voice signal with a level from low voltage changes to high voltage, the power output will resume.

7. The voice control energy-saving power socket of claim 1, wherein when the output control circuit is in power-up state, the voice control circuit power will shut off and new voice signal will not produce commanding effect on the circuit.
